(19) United States
(12) Patent Application Publication
(10) Pub. No.: US 2025/0243756 A1
(43) Pub. Date: Jul. 31, 2025

(54) SURFACE LEAK RATE ESTIMATION FOR CONTROLLING HYDROCARBON PRODUCTION OPERATIONS

(71) Applicant: Saudi Arabian Oil Company, Dhahran (SA)

(72) Inventors: Mohammed A. AlHuraifi, Al-Qatif (SA); Rashad I. AlMilad, Al-Qatif (SA); Abdulrahman Mishkhes, Dhahran (SA); Mubarak J. Al-Shammari, Dhahran (SA)

(21) Appl. No.: 18/427,471

(22) Filed: Jan. 30, 2024

(51) Int. Cl. E21B 47/117; F17D 5/02

(52) U.S. Cl. CPC E21B 47/117; F17D 5/02; E21B 2200/20

(57) ABSTRACT

Systems and methods are for determining a leak volume of a hydrocarbon production network by operations including accessing a model of the hydrocarbon production network, the model specifying values for operational parameters representing operation of at least one well in the hydrocarbon production network, at least one pipeline in the hydrocarbon production network, and a fluid transported in the hydrocarbon production network; calibrating the model based on values of sensor data measured from one or more sensors in the hydrocarbon production network, the sensor data representing operation of the hydrocarbon production network; detecting a leak in the hydrocarbon production network; executing a simulation of the model, wherein the detected leak in the hydrocarbon production network is inserted into the model; and generating an estimate of lost production from the leak in the hydrocarbon production network.

### TECHNICAL FIELD

This specification relates to control systems at hydrocarbon production facilities. Specifically, this specification relates to modeling flow and estimating volumes of production leaks in hydrocarbon production networks.

### BACKGROUND

Drilling a hydrocarbon well has challenges due to a harsh environment downhole. In addition to the high temperature, high pressure, highly acidic and corrosive environments encountered in deep wells, there are destructive, dynamic conditions such as high torque, shock, and vibration created by the drill bit grinding and penetrating through rock formations. These conditions can make drilling challenging. Logging and directional instruments are used to acquire measurements and provide an accurate representation of the well while drilling over extended periods of time.

Hydrocarbon production facilities transport hydrocarbons through pipelines that connect wells to a hydrocarbon production facility (e.g., a refinery). Pipeline networks can be complex and include lines from a plurality of wells that produce at different rates and pressures.

### SUMMARY

Systems and processes are configured for controlling flow of hydrocarbons in a production facility responsive to detecting leaks using multi-flow simulation data. A data processing system uses estimates of surface multi-phase leak rates, when leaks develop at the surface network of an oil production system, to determine an extent of released hydrocarbon material in gaseous and aqueous phases.

The data processing system executes multi-phase simulations of hydrocarbon flow to quantify a surface leak rate in a pipeline that is transferring hydrocarbon production, such as oil or gas, from a group of oil production wells to another facility, such as a refinery. The data processing system includes a calibrated production network. The production network includes production wells, fluid model(s), a pipeline network, and a production facility. The production network is calibrated based on the simulations to establish baseline operational parameter values. The data processing system can also determine different values for the operational parameters that indicate that a leak is present. For example, a leak or leaks can be inserted into the model of the hydrocarbon production network. The data processing system executes a flow simulation and estimates the leak rate of multi-phase fluids against boundary pressure conditions.

The one or more embodiments described in this specification can enable one or more of the following advantages. The data processing system is calibrated to quickly estimate rates of leaks within the production network. The fast detection of leaks within a production network can estimate the volume of hydrocarbons that are released into an environment around the hydrocarbon production system.

The data processing system can estimate rates of leaks even when the production network includes a dynamic environment in which many wells are operating and contributing to pressures within the pipeline network. For example, dozens or hundreds of wells can be linked together, and each of these wells may sometimes be producing more or less than at other times and contribute different amounts of pressure and amounts of production (hydrocarbons) to the pipeline network. A change in a pressure at one location can affect changes in pressure at other locations, masking a leak or other issue within the pipeline network. The data processing system is configured to recognize when there are anomalies in sensor data collected from the pipeline network that may otherwise be undetectable in isolation, such as when viewing individual sensor values on a traditional user interface.

The system can determine an approximate volume of released hydrocarbon material in gaseous and aqueous phases. The determination of the volume of release hydrocarbons can enable an operator to more accurately determine a total production output of the hydrocarbon production network.

Embodiments of these systems and methods can include one or more of the following features.

In an aspect, a method for determining a leak volume of a hydrocarbon production network includes the following operations. The method includes accessing a model of the hydrocarbon production network, the model specifying values for operational parameters representing operation of at least one well in the hydrocarbon production network, at least one pipeline in the hydrocarbon production network, and a fluid transported in the hydrocarbon production network. The method includes calibrating the model based on values of sensor data measured from one or more sensors in the hydrocarbon production network, the sensor data representing operation of the hydrocarbon production network. The method includes detecting a leak in the hydrocarbon production network. The method includes executing a simulation of the model, wherein the detected leak in the hydrocarbon production network is inserted into the model. The method includes generating an estimate of lost production from the leak in the hydrocarbon production network.

In some implementations, accessing a model of the hydrocarbon production network includes obtaining network data describing the hydrocarbon production network, the network data including well data describing a configuration of the at least one well in the hydrocarbon production network, pipeline data describing the at least one pipeline in the hydrocarbon production network, and fluid data describing the fluid transported in the hydrocarbon production network. In some implementations, accessing a model of the hydrocarbon production network includes configuring the at least one well, the at least one pipeline, and a flow of the fluid based on the network data.

In some implementations, calibrating the model of the hydrocarbon production network includes: obtaining sensor data including pressure data and flow data; based on measured values of the sensor data, adjusting operational parameter values of the at least one well, the at least one pipeline, and a flow of the fluid in accordance with the measured values of the sensor data; obtaining pressure data from the model near a leak location in the model of the hydrocarbon production network; generating the leak at the leak location; executing a simulation of the model including the leak; and determining that a simulated pressure value from the simulation of the model matches the pressure data from the model within a threshold tolerance.

In some implementations, the process includes generating a pressure boundary condition, wherein determining that the simulated pressure value from the simulation of the model matches the pressure data is based on the pressure boundary condition.

In some implementations, executing the simulation of the model occurs in real-time relative to the leak occurring in the hydrocarbon production network.

In some implementations, generating the estimate of lost production from the leak in the hydrocarbon production network includes determining a time period of the leak; determining a flow of the fluid to the leak based on one or more pressure values near the leak; and based on the one or more pressure values and the time period, determine a volume of hydrocarbons lost in the leak.

In some implementations, the volume of hydrocarbons includes gaseous hydrocarbons, aqueous hydrocarbons, or both.

In an aspect, a system for determining a leak volume of a hydrocarbon production network includes at least one processor; and memory storing instructions that, when executed by the at least one processor, cause the at least one processor to perform operations of methods described herein.

One or more non-transitory computer readable media storing instructions that, when executed by when executed by at least one processor, cause the at least one processor to perform operations of methods described herein.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 shows an illustration of an example well drilling rig.

FIG. 2 shows a block diagram illustrating an example system for surface leak rate estimation for controlling hydrocarbon production operations.

FIG. 3 shows an example of a production network.

FIG. 4 shows a block diagram illustrating an example process for surface leak rate estimation for controlling hydrocarbon production operations.

FIGS. 5A-5B show examples of a production network.

FIG. 6 shows an example graph of simulation results.

FIG. 7 shows a block diagram illustrating an example process for estimating the lost production from leak in the hydrocarbon production network.

FIG. 8 illustrates hydrocarbon production operations.

FIG. 9 is a diagram of an example computing system.

### DETAILED DESCRIPTION

Systems and processes are configured for controlling flow of hydrocarbons in a production facility responsive to detecting leaks using multi-flow simulation data. A data processing system uses estimates of surface multi-phase leak rates, when leaks develop at the surface network of an oil production system, to determine an extent of released hydrocarbon material in gaseous and aqueous phases.

The data processing system executes multi-phase simulations of hydrocarbon flow to quantify a surface leak rate in a pipeline that is transferring hydrocarbon production, such as oil or gas, from a group of oil production wells to another facility, such as a refinery. The data processing system includes a calibrated production network. The production network includes production wells, fluid model(s), a pipeline network, and a production facility. The production network is calibrated based on the simulations to establish baseline operational parameter values. The data processing system can also determine different values for the operational parameters that indicate that a leak is present. For example, a leak or leaks can be inserted into the model of the hydrocarbon production network. The data processing system executes a flow simulation and estimates the leak rate of multi-phase fluids against boundary pressure conditions.

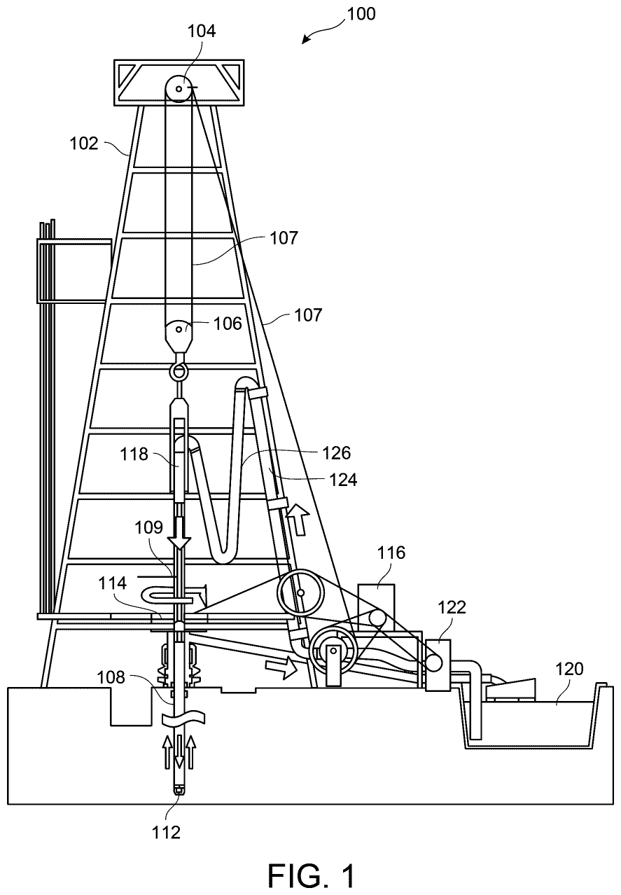

FIG. 1 shows an illustration of an example well drilling rig 100. A derrick 102 provides a structure that supports the drilling equipment. A crown block 104 mounted at the top of the derrick 102, a traveling block 106, and a drill line 107 connected between the crown block 104 and the traveling block 106 move the drill string 108 vertically. The drill string 108 includes a plurality of sections of drill pipe 110, a kelly bar 109, and a drill bit 112 or other bottom hole assembly. The kelly bar 109 is a square section of pipe that interfaces with a rotary table 114 to transfer torque from a motor or engine 116 to the drill string 108. A swivel 118 is connected between the top of the drill string 108 and the traveling block 106. The swivel 118 allows the drill string 108 to turn without turning the traveling block 106.

A drilling fluid or mud is used to remove cuttings from the well during drilling. A mud tank 120 holds the mud. A mud pump 122 pumps the mud from the mud tank 120 to the swivel 118 via a rigid standpipe 124 and a flexible hose 126. The mud is pumped through the center of the drill string 108 to the bottom of the hole through the drill bit 112. The mud returns to the surface carrying the cuttings through the annulus formed between the wall of the well and the outside of the drill string 108. The mud returns to the mud tank 120 via a flow line 128 where the cuttings are filtered, and the mud recirculates through the system.

As the drill string 108 rotates, the drill bit 112 engages with and cuts the bottom of the hole penetrating a subsurface formation. The rate at which the drill bit penetrates the formation is called the rate of penetration (ROP). The weight on the drill bit (WOB) is controlled by the amount of tension applied to the drill line 107 and can affect the ROP.

The motor or engine 116 that turns the drill bit and raises and lowers the drill string, the mud pump 122 and other equipment located on or near the drilling rig such as generators, burn fuel and emit carbon dioxide, CO₂. The amount of CO₂ emitted can be proportional to the fuel consumed by the drilling rig. Fuel consumption and CO₂ emissions can be reduced by optimizing various drilling parameters.

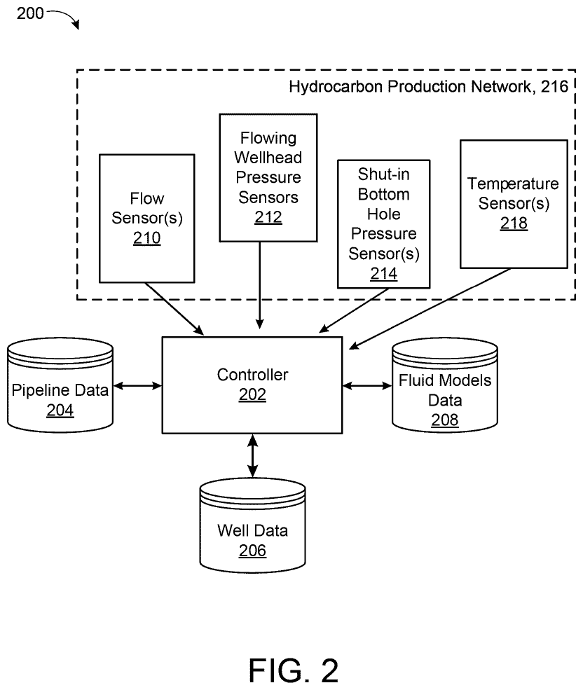

FIG. 2 shows a block diagram illustrating an example system 200 for surface leak rate estimation for controlling hydrocarbon production operations. The system 200 includes a controller 202 that is connected to a hydrocarbon network 216. The controller 202 is configured to receive data from a set of sensors within the hydrocarbon network 216. Examples of the sensors include flow sensors 210, flowing wellhead pressure sensors 212, shut-in bottom hole pressure sensors 214, and temperature sensors 218. The example sensors 210, 212, and 214 are given for illustrative purposes and do not represent a comprehensive set of sensors that are present within the hydrocarbon network 216. For example, additional sensors can be added for one or more components or accessories of the hydrocarbon production network. The additional sensors can include sensors configured to measure data of wells in the completion, tubing, casing, safety valves, and so forth to measure pressure, temperatures, flow rates, and other such data within the hydrocarbon production network. In some implementations, the sensors can also include downhole sensors within wells that measure pressures within the wells or at the surface of the well.

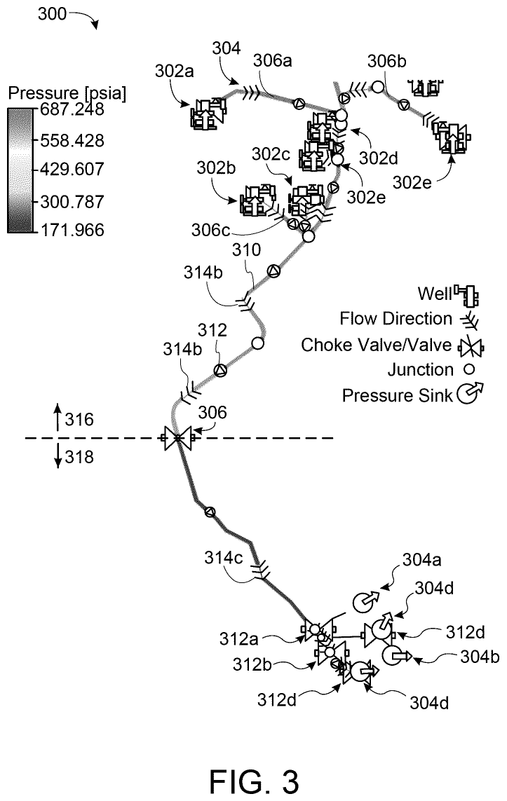

The sensors 210, 212, 214, and 218 of the hydrocarbon network 216 can be distributed throughout the wells and pipeline network of the hydrocarbon production network, as described subsequently in relation to FIG. 3. for example, flow sensors can be distributed throughout different branches of the pipeline to measure production as it flows through the respective branches. Pressure sensors can also be distributed throughout the pipeline network both along branches and at merge points of the branches where multiple pipelines intersect. The distribution of the sensors throughout the hydrocarbon production network 216 balances a minimization of cost while also acquiring enough data to detect leaks as they happen. Therefore, the distribution of sensors 210, 212, 214, and 218 within the hydrocarbon production network 216 can be very particular to the respective implementation of a hydrocarbon network and its various pipeline configurations and well configurations.

The system 200 for surface leak estimation further includes a set of data sources 204, 206, and 208 that provide data describing the hydrocarbon production network 216 to enable the controller 202 to interpret the data from the sensors 210, 212, 214, and 218 for detection of leaks. Specifically, the set of data sources 204, 206, and 208 provide data describing the physical configuration of hardware within the hydrocarbon production network 216.

The hardware can include pipelines and their geometries. The hardware can include the arrangement of pipelines within the hydrocarbon production network 216. For example, the pipeline data 204 can include data that specifies, for each of the pipelines in the network, an elevation profile, diameter, material, and relationship to one or more other pipelines within the production network. The pipeline data 204 can also include, for each pipe, a roughness and a length of a pipe or section of the pipe, and an elevation profile of a pipe.

The hardware can include a plurality of wells within the hydrocarbon production network 216. For example, the well data 206 from the set of data sources can describe for each of the wells a construction model of the well, a tubing diameter and length, a completion, presence of safety valves and choke valves, pressure and temperature values for that well, a productivity index representing nominal production volumes, and other well operation information.

The fluid models data 208 includes fluid modeling data for a variety of fluid types or compositions. For example, the modeling data can be a compositional fluid model or a black oil model including American Petroleum Institute (API) gravity values for the fluid, gas oil ratio data, density data for all fluids (oil, water and gas), viscosity data, and impurities data representing no-hydrocarbon impurities within the fluid. The fluid models data can also include a value for a formation volume factor for all fluids (oil, water and gas).

The controller 202 is configured to receive data from the data sources and perform a simulation of operation of the hydrocarbon production network 216. The controller can therefore establish a baseline for values of various operational parameters of the hydrocarbon production network 216. The simulation can be executed by simulating values from each of the sensors 210, 212, 214, and 218 present within the hydrocarbon production network 216 in combination with the data from sources 204, 206, and 208. The controller 202 can therefore establish these baseline values under what is nominal operation of the hydrocarbon production network 216. Once these baseline values are established, one or more leaks are introduced into the hydrocarbon production network 216 at known locations and severities. The controller 202 can measure the changed values from the sensors 210, 212, 214, and 218 in the hydrocarbon production network 216 described by data from sources 204, 206, 208. The controller 202 can refine the tolerance of deviation of values of one or more operational parameters from the expected or baseline values based on the introduction of the leaks and the amount in which the operational parameter values are changed responsive to the introduced leak(s). Refining the parameter thresholds by performance of the simulation can help ensure that there are few false positives for leak detection but also that when leaks do occur, they are detected quickly. In some implementations, machine learning can be used to set the various tolerance thresholds that represent leaks within the system.

The system 200 is flexible in that data for various different instances of the hydrocarbon production network 216 can be stored in data sources 204, 206, and 208. The controller 202 can re-execute the simulation for the particular instance of the hydrocarbon production network 216. The controller 202 can therefore establish baseline values that are appropriate for any particular hydrocarbon production network 216 configuration. In another example, the configuration of a particular hydrocarbon network 216 can be updated. For example, the hydrocarbon production network 216 can have an addition of additional well, additional pipeline, replaced pipeline, or any other change to hardware within the network. The controller 202 is configured to re-execute the simulation of production operations at the updated network and reestablish baseline values for various operational parameters and re-profile an occurrence of one or more leaks within the hydrocarbon production network 216.

The controller 202 is configured to gather data from the sensors 210, 212, 214, and 218, and data from data sources 204, 206, and 208 during operation of the hardware of the hydrocarbon production network 216. As subsequently described in additional detail, the controller 202 continually monitors data received and determines whether or not a leak is present in the hydrocarbon production network 216. One or more leaks can be detected when the measured operational parameters of the hydrocarbon production network 216 deviate outside of threshold amount from unexpected value of those respective operational parameters of the hydrocarbon production network. a tolerance for these operational parameters can be refined based on heuristic data from actual operation of the hydrocarbon production network and associated detected leaks and from simulations performed using the data describing the hydrocarbon production network.

FIG. 3 shows an example of a hydrocarbon production network 300, such as an instance of the hydrocarbon production network 216 of FIG. 2. The network 300 includes pipelines 306a, 306b, and 306c that merge into a central pipeline 310. Arrows, such as arrow 312, show a direction of fluid flow within each of the pipelines 306a-c and 310. The flow can be monitored by a set of flow sensors including flow sensors 304, 314a-c, which are labeled for illustrative purposes, as other flow sensors are present throughout the network 300 and represented with similar symbols as for flow sensors 304 and 314a-c.

Wells 302a-c are connected by pipelines 306a-c and 310. Wells 302d-e are connected by pipelines (hidden by hardware symbols) to pipeline 310. Each of the wells 302a-e is associated with a set of well hardware, including valves, pressure sensors, flow sensors and temperature sensors, shown as symbols in FIG. 3.

A valve 306 on pipeline 310 separates a first portion 316 of the network from a second portion 318 of the network. The portions of the pipeline 310 that are in the region 316 of the network 300 are shown at a relatively high pressure (e.g., over 600 pounds per square inch absolute, or about 4.12 Megapascals). A portion of the pipeline 310 in the network 300 that is downstream from the valve 306 is shown at a relatively low pressure (e.g., under 170 pounds per square inch absolute, or about 1.172 Megapascals).

The relatively high pressure of the pipeline 310 and pipelines 302a-c for wells 302a-d upstream of the valve 306 can be indicative of a partial valve closure in region 318 of the network 300. A controller or data processing system determines a threshold pressure for generating an alert of approaching or exceeding the maximum allowable operating pressure on simulating production operations in the hydrocarbon production network 300. The controller or data processing system further determines nominal pressure values for regions 316 and 318 and tolerance values within which no leak is suspected of occurring for those baseline operational parameter values.

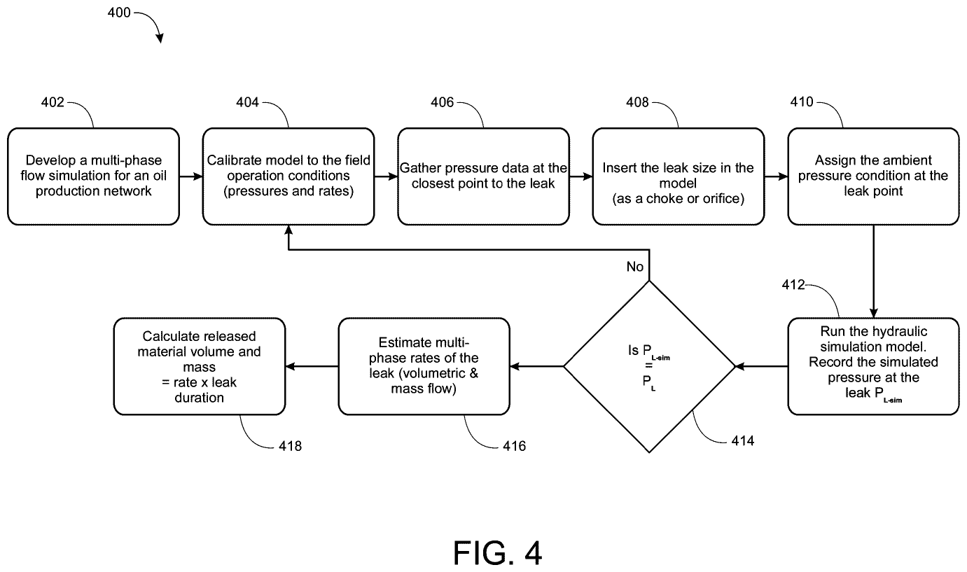

To estimate the multi-phase rates of a leak, the controller can measure values at valves 312a-d in the portion 318 of the pipeline 310. Pressure values can be measured at pressure sensors 304a-d at these valves 312a-d within the portion 318 of the pipeline 310. In this example, the pressure values measured at pressure sensors 304a-d are lower than an expected nominal operational parameter value for the pipeline 310. For example, the recorded pressure at the pipeline and the ambient pressure at the leak condition (e.g., 10 KPa, 100 KPa, 1 MPA, etc.) can be used to estimate the multi-phase rates of the leaks at the region 318. The process is subsequently described in greater detail with respect to FIG. 4.

FIG. 4 shows a block diagram illustrating an example process 400 for surface leak rate estimation for controlling hydrocarbon production operations. The process 400 can be performed by a data processing system, such as controller 202 of system 200 of FIG. 2. In some implementations, the data processing system can perform the actions of process 400 individually or in different orders or combinations.

The data processing system is configured to develop (402) a model for an oil-production system (using a multiphase flow simulation software). The model can include well models, pipeline models, and fluid models. The well models can include completion, tubing, casing, pressure, and accessories data. The model can be developed using a multi-phase flow simulation software (e.g. PipeSim™, Prosper™, and so forth). In the model, all components and accessories of the wells can be included, such as completion, tubing, casing, and safety valves. In some implementations, the data processing system uses actual data to calibrate the well models, including the fluid model, pressure, temperature, and rate operational parameters. The pipeline model models the behavior of each of the pipelines in the network, as previously described. The parameters of the pipeline model include pipe diameter, elevation profile, roughness, and pipe length. A fluid model can include a compositional fluid model or black oil model. The parameters of the fluid model include API gravity, gas-oil ratio, density, viscosity, non-hydrocarbon impurities, and a formation volume factor.

The data processing system is configured to calibrate (404) the model to the field operation conditions prior to the leak incident. The calibration of the model is based on data specific to a particular instance of the hydrocarbon production network. The calibration is based on well-related data including historical production rate values, flowing wellhead pressure values, and shut-in bottom hole pressures at the reservoir. The calibration is based on pressure data at different points of the production network. The data processing system performs the calibration using statistical analysis, such as regression. The data processing system can perform the statistical analysis on network parameters that have a low certainty, such as a productivity index, until simulated data (e.g., pressure and rate) match measured data of actual network conditions.

The data processing system is configured to obtain (406) pressure data at a closest available point to the leak (PL). The data processing system receives data representing where a leak being inserted based on field reporting after developing a leak.

The data processing system is configured to insert (408) a leak having a specified size at a choke or orifice in the developed model. The data processing system can insert one leak or several leaks into the model. The leak can be for either aqueous or gaseous production.

The data processing system is configured to assign (410) boundary pressure conditions to the model to improve the model accuracy. The boundary pressure conditions can include boundaries on atmospheric pressure if the pipeline is above-ground, overburden pressure if the pipeline is underground, and hydrostatic pressure if the pipeline is offshore. The boundary conditions make the model more accurate because they result in a more accurate estimation of the multi-phase rates of a leak. Specifically, the rates of a leak are dependent on the boundary conditions against which a leak stream flows.

The data processing system is configured to execute (412) the generated model. Specifically, the data processing system runs the simulation using the calibrated parameter values from the model. The measured values of the pressure that are upstream from the leak are compared to the gathered pressure in proximity to the leak. The pressures should be within a threshold tolerance (e.g., 5%, 2%, 1%, 0%, or another threshold defined by the data processing system).

The data processing system is configured to determine (414) whether the simulated pressure P_{L-sim} is equal to the leak pressure P_{L} or within the specified threshold. If this condition is not satisfied, the data processing system repeats the calibration (404). If a match is found the data processing system proceeds to finalize the model and use the model to estimate leaks and production losses.

The data processing system is configured to estimate (416) multi-phase rates of the leak as simulated by the model at the inserted leak. The rates can include volumetric leak rate or mass flow rate of oil, gas and water. The rate estimation is based on a hydraulic simulation. The simulator incorporates multi-phase flow correlations, fluid models and production system equipment. These allow calculation of flow regimes, pressure losses at prevailing conditions for multi-phase flow.

The data processing system is configured to determine (418) an estimated released material in volume or mass by multiplying the leak rate by the duration of the leak from when the leak started to when the leak was isolated in the production network. The data processing system thus validates the model and can apply it to actual production networks for detecting leaks and estimating production losses.

The data processing system can use this calibrated and validated model to quantify the multi-phase leak rates using a multi-phase simulation model. This can be done without accessing an observed pressure profile slope change across the leak. The leak rate estimation does not rely on quantifying a leak rate across a hole, which is not an accurate estimation approach suitable for production systems because this approach ignores upstream conditions and does not apply to multi-phase rates. The data processing system determines multi-phase leak rates at a leak based on conditions throughout the production network.

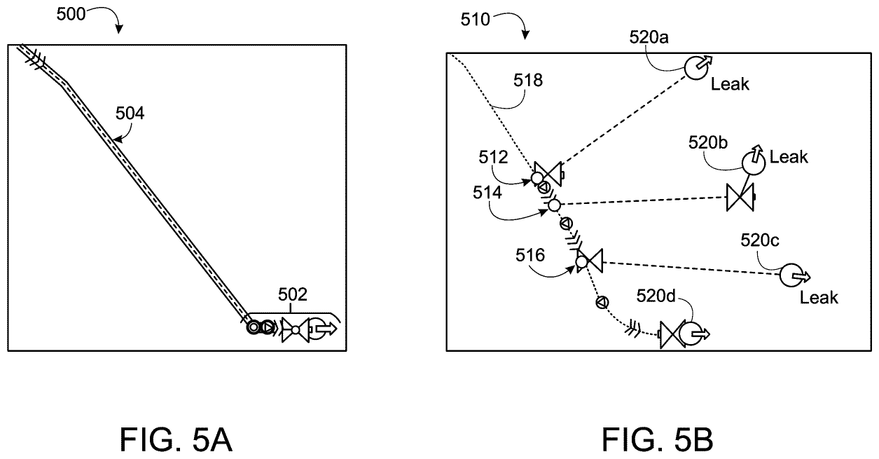

FIG. 5A shows an example of a production network 500 in which leaks can be detected based on the process 400 previously described. In the production network 500, a pipeline is shown that terminates in choke point 502. In this example, the pipeline 504 is operating nominally and no leaks are detected. The production network 500 can be similar to region 316 of production network 300.

FIG. 5B shows an example of a production network 510 in which a leak is detected at choke points 512, 514, and 516. Production network 510 can be similar to region 318 of the production network 300. In this example, the pressure in the pipeline 518 has fallen below a threshold value. Valves at each of the choke points 512, 514, and 516 are coupled to pressure sensors. At each of the three pressure sensors 520a-d, a leak is detected. The data processing system can use the choke points 512, 514, and 516 to isolate the leak and estimate a production loss as described previously. In a first example, the leak has been inserted near the choke points 512, 514, or 516. In this example, the data processing system measures pressure values in the pipeline 518 and calibrates the simulation. In a second example, the leak is detected near one of choke points 512, 514, 516, and the data processing system determines a location of the leak and attempts to isolate the leak.

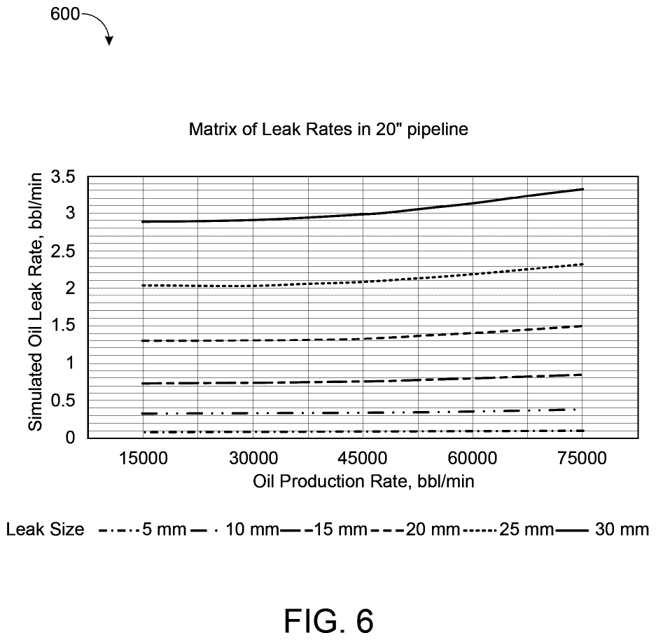

FIG. 6 shows an example graph 600 of simulation results. Specifically, the graph 600 shows a matrix of simulated oil leak rates at different oil production rates with a gas-oil ratio of 400 standard cubic foot per stock tank barrel (scf/stb) in a 20-inch (50.8 centimeter) above-ground pipeline for a surface leak ranges between 5 millimeters and 30 millimeters. The oil leak rates can be determined based on the calibrated simulation calibrated by process 400 as previously described.

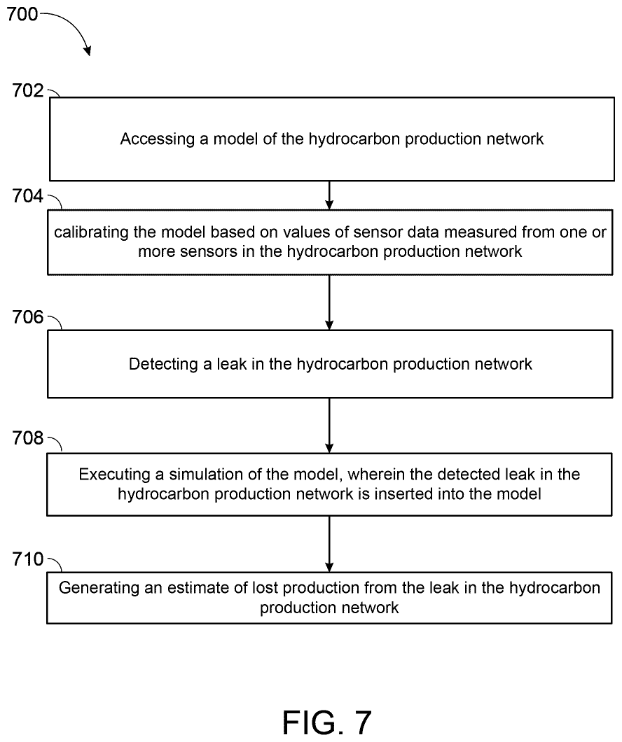

FIG. 7 shows an example process 700 for determining a leak volume of a hydrocarbon production network, as described herein. In some implementations, the process 700 is performed by a data processing system (such as data processing system 200 of FIG. 2) including one or more processors.

The process 700 includes accessing (702) a model of the hydrocarbon production network. The model specifies values for operational parameters representing operation of at least one well in the hydrocarbon production network, at least one pipeline in the hydrocarbon production network, and a fluid transported in the hydrocarbon production network.

In some implementations, accessing a model of the hydrocarbon production network comprises obtaining network data describing the hydrocarbon production network, the network data comprising well data describing a configuration of the at least one well in the hydrocarbon production network, pipeline data describing the at least one pipeline in the hydrocarbon production network, and fluid data describing the fluid transported in the hydrocarbon production network. Generating the model comprises configuring the at least one well, the at least one pipeline, and a flow of the fluid based on the network data.

The process 700 includes calibrating (704) the model based on values of sensor data measured from one or more sensors in the hydrocarbon production network. The sensor data represents operation of the hydrocarbon production network.

In some implementations, calibrating the model of the hydrocarbon production network comprises obtaining sensor data comprising pressure data and flow data, and based on measured values of the sensor data, adjusting operational parameter values of the at least one well, the at least one pipeline, and a flow of the fluid in accordance with the measured values of the sensor data.

In some implementations, the calibrating comprises obtaining pressure data from the model near a leak location in the model of the hydrocarbon production network, generating the leak at the leak location, executing a simulation of the model including the leak, and determining that a simulated pressure value from the simulation of the model matches the pressure data from the model within a threshold tolerance.

In some implementations, the calibrating further comprises generating a pressure boundary condition, wherein determining that the simulated pressure value from the simulation of the model matches the pressure data is based on the pressure boundary condition.

The process 700 includes detecting (706) a leak in the hydrocarbon production network. The process 700 includes executing (708) a simulation of the model. The detected leak in the hydrocarbon production network is inserted into the model for the simulation. In some implementations, executing the simulation of the model occurs in real-time relative to the leak occurring in the hydrocarbon production network.

The process 700 includes generating (710) an estimate of lost production from the leak in the hydrocarbon production network. In some implementations, generating the estimate of lost production from the leak in the hydrocarbon production network comprises determining a time period of the leak, determining a flow of the fluid to the leak based on one or more pressure values near the leak, and based on the one or more pressure values and the time period, determine a volume of hydrocarbons lost in the leak. In some implementations, the volume of hydrocarbons includes gaseous hydrocarbons, aqueous hydrocarbons, or both.

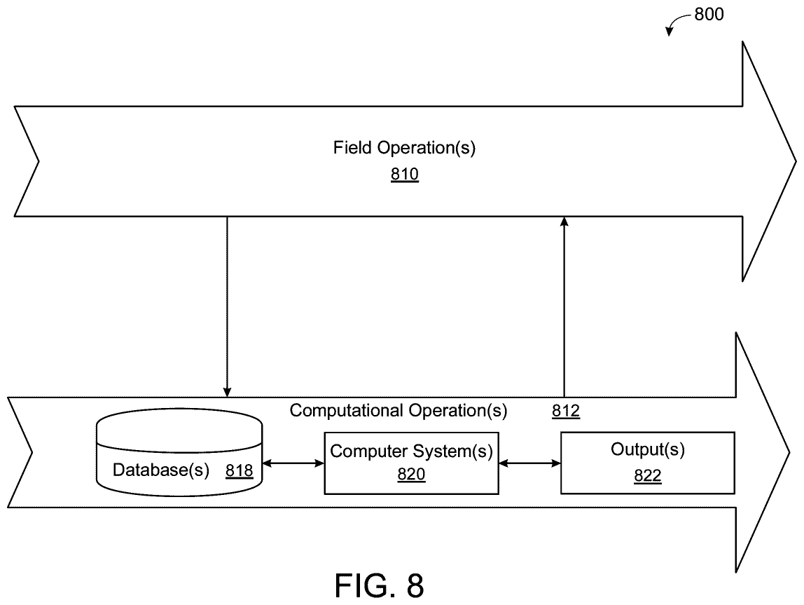

FIG. 8 illustrates hydrocarbon production operations 800 that include both one or more field operations 810 and one or more computational operations 812, which exchange information and control exploration to produce hydrocarbons. In some implementations, outputs of techniques of the present disclosure (e.g., the method 300) can be performed before, during, or in combination with the hydrocarbon production operations 800, specifically, for example, either as field operations 810 or computational operations 812, or both. For example, the processes 300, 320 collect data during field operations, processes the data in computational operations, and can determine locations to perform additional field operations.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 8 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

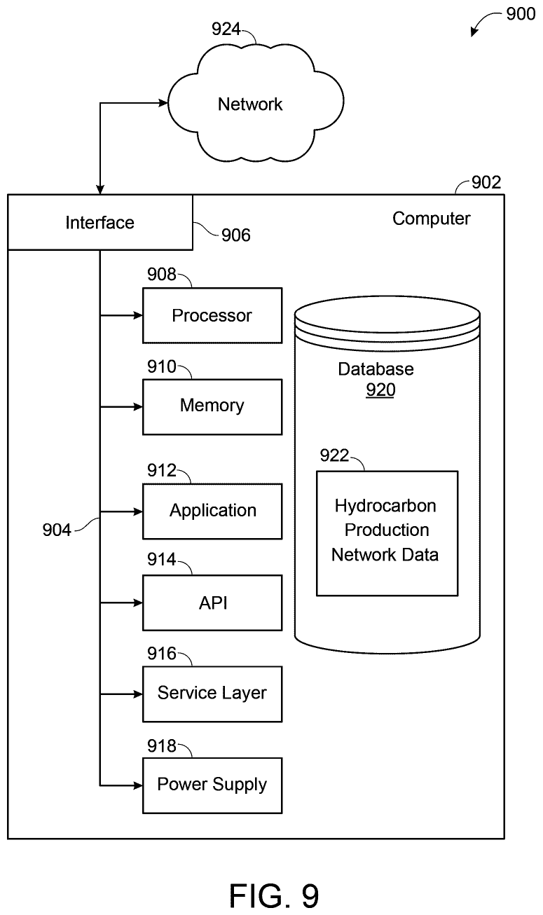

FIG. 9 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 924. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 924 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 904. In some implementations, any or all of the components of the computer 902, including hardware or software components, can interface with each other or the interface 906 (or a combination of both), over the system bus 904. Interfaces can use an application programming interface (API) 914, a service layer 916, or a combination of the API 914 and service layer 916. The API 914 can include specifications for routines, data structures, and object classes. The API 914 can be either computer-language independent or dependent. The API 914 can refer to a complete interface, a single function, or a set of APIs.

The service layer 916 can provide software services to the computer 902 and other components (whether illustrated or not) that are communicably coupled to the computer 902. The functionality of the computer 902 can be accessible for all service consumers using this service layer. Software services, such as those provided by the service layer 916, can provide reusable, defined functionalities through a defined interface. For example, the interface can be software written in JAVA, C++, or a language providing data in extensible markup language (XML) format. While illustrated as an integrated component of the computer 902, in alternative implementations, the API 914 or the service layer 916 can be stand-alone components in relation to other components of the computer 902 and other components communicably coupled to the computer 902. Moreover, any or all parts of the API 914 or the service layer 916 can be implemented as child or sub-modules of another software module, enterprise application, or hardware module without departing from the scope of the present disclosure.

The computer 902 includes an interface 906. Although illustrated as a single interface 906 in FIG. 9, two or more interfaces 906 can be used according to implementations of the computer 902 and the described functionality. The interface 906 can be used by the computer 902 for communicating with other systems that are connected to the network 924 (whether illustrated or not) in a distributed environment. Generally, the interface 906 can include, or be implemented using, logic encoded in software or hardware (or a combination of software and hardware) operable to communicate with the network 924. More specifically, the interface 906 can include software supporting one or more communication protocols associated with communications. As such, the network 924 or the interface's hardware can be operable to communicate physical signals within and outside of the illustrated computer 902.

The computer 902 includes a processor 908. Although illustrated as a single processor 908 in FIG. 9, two or more processors 908 can be used according to implementations of the computer 902 and the described functionality. Generally, the processor 908 can execute instructions and can manipulate data to perform the operations of the computer 902, including operations using algorithms, methods, functions, processes, flows, and procedures as described in the present disclosure.

The computer 902 also includes a database 920 that can hold data (such hydrocarbon production network data 922) for the computer 902 and other components connected to the network 924 (whether illustrated or not). For example, database 920 can be in-memory or a database storing data consistent with the present disclosure. In some implementations, database 920 can be a combination of two or more different database types (for example, hybrid in-memory and conventional databases) according to implementations of the computer 902 and the described functionality. Although illustrated as a single database 920 in FIG. 9, two or more databases (of the same, different, or combination of types) can be used according to implementations of the computer 902 and the described functionality. While database 920 is illustrated as an internal component of the computer 902, in alternative implementations, database 920 can be external to the computer 902.

The computer 902 also includes a memory 910 that can hold data for the computer 902 or a combination of components connected to the network 924 (whether illustrated or not). Memory 910 can store any data consistent with the present disclosure. In some implementations, memory 910 can be a combination of two or more different types of memory (for example, a combination of semiconductor and magnetic storage) according to implementations of the computer 902 and the described functionality. Although illustrated as a single memory 910 in FIG. 9, two or more memories 910 (of the same, different, or combination of types) can be used according to implementations of the computer 902 and the described functionality. While memory 910 is illustrated as an internal component of the computer 902, in alternative implementations, memory 910 can be external to the computer 902.

The application 912 can be an algorithmic software engine providing functionality according to implementations of the computer 902 and the described functionality. For example, application 912 can serve as one or more components, modules, or applications. Further, although illustrated as a single application 912, the application 912 can be implemented as multiple applications 918 on the computer 902. In addition, although illustrated as internal to the computer 902, in alternative implementations, the application 912 can be external to the computer 902.

The computer 902 can also include a power supply 918. The power supply 918 can include a rechargeable or non-rechargeable battery that can be configured to be either user- or non-user-replaceable. In some implementations, the power supply 918 can include power-conversion and management circuits, including recharging, standby, and power management functionalities. In some implementations, the power-supply 918 can include a power plug to allow the computer 902 to be plugged into a wall socket or a power source to, for example, power the computer 902 or recharge a rechargeable battery.

There can be any number of computers 902 associated with, or external to, a computer system including the computer 902, with each computer 902 communicating over network 924. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Certain features that are described in this specification in the context of separate implementations can also be implemented, in combination, in a single implementation. Conversely, various features that are described in the context of a single implementation can also be implemented in multiple implementations, separately, or in any suitable sub-combination. The separation or integration of various system modules and components in the previously described implementations should not be understood as requiring such separation or integration in all implementations, and the described program components and systems can generally be integrated together in a single product or packaged into multiple products.

Accordingly, the previously described example implementations do not define or constrain the present disclosure. It will be understood that various modifications may be made without departing from the scope of the systems and methods described herein. Accordingly, other embodiments are within the scope of the following claims.

What is claimed is:

1. A method for determining a leak volume of a hydrocarbon production network, the method comprising:
accessing a model of the hydrocarbon production network, the model specifying values for operational parameters representing operation of at least one well in the hydrocarbon production network, at least one pipeline in the hydrocarbon production network, and a fluid transported in the hydrocarbon production network;
calibrating the model based on values of sensor data measured from one or more sensors in the hydrocarbon production network, the sensor data representing operation of the hydrocarbon production network;
detecting a leak in the hydrocarbon production network;
executing a simulation of the model, wherein the detected leak in the hydrocarbon production network is inserted into the model; and
generating an estimate of lost production from the leak in the hydrocarbon production network.

2. The method of claim 1, wherein accessing a model of the hydrocarbon production network comprises:
obtaining network data describing the hydrocarbon production network, the network data comprising well data describing a configuration of the at least one well in the hydrocarbon production network, pipeline data describing the at least one pipeline in the hydrocarbon production network, and fluid data describing the fluid transported in the hydrocarbon production network; and
configuring the at least one well, the at least one pipeline, and a flow of the fluid based on the network data.

3. The method of claim 1, wherein calibrating the model of the hydrocarbon production network comprises:
obtaining sensor data comprising pressure data and flow data;
based on measured values of the sensor data, adjusting operational parameter values of the at least one well, the at least one pipeline, and a flow of the fluid in accordance with the measured values of the sensor data;
obtaining pressure data from the model near a leak location in the model of the hydrocarbon production network;
generating the leak at the leak location;
executing a simulation of the model including the leak; and
determining that a simulated pressure value from the simulation of the model matches the pressure data from the model within a threshold tolerance.

4. The method of claim 3, further comprising:
generating a pressure boundary condition, wherein determining that the simulated pressure value from the simulation of the model matches the pressure data is based on the pressure boundary condition.

5. The method of claim 1, wherein executing the simulation of the model occurs in real-time relative to the leak occurring in the hydrocarbon production network.

6. The method of claim 1, wherein generating the estimate of lost production from the leak in the hydrocarbon production network comprises:
determining a time period of the leak;
determining a flow of the fluid to the leak based on one or more pressure values near the leak; and
based on the one or more pressure values and the time period, determine a volume of hydrocarbons lost in the leak.

7. The method of claim 6, wherein the volume of hydrocarbons includes gaseous hydrocarbons, aqueous hydrocarbons, or both.

8. A system for determining a leak volume of a hydrocarbon production network, the system comprising:
at least one processor; and
memory storing instructions that, when executed by the at least one processor, cause the at least one processor to perform operations comprising:
accessing a model of the hydrocarbon production network, the model specifying values for operational parameters representing operation of at least one well in the hydrocarbon production network, at least one pipeline in the hydrocarbon production network, and a fluid transported in the hydrocarbon production network;
calibrating the model based on values of sensor data measured from one or more sensors in the hydrocarbon production network, the sensor data representing operation of the hydrocarbon production network;
detecting a leak in the hydrocarbon production network;
executing a simulation of the model, wherein the detected leak in the hydrocarbon production network is inserted into the model; and
generating an estimate of lost production from the leak in the hydrocarbon production network.

9. The system of claim 8, wherein accessing a model of the hydrocarbon production network comprises:
obtaining network data describing the hydrocarbon production network, the network data comprising well data describing a configuration of the at least one well in the hydrocarbon production network, pipeline data describing the at least one pipeline in the hydrocarbon production network, and fluid data describing the fluid transported in the hydrocarbon production network; and
configuring the at least one well, the at least one pipeline, and a flow of the fluid based on the network data.

10. The system of claim 8, wherein calibrating the model of the hydrocarbon production network comprises:
obtaining sensor data comprising pressure data and flow data;
based on measured values of the sensor data, adjusting operational parameter values of the at least one well, the at least one pipeline, and a flow of the fluid in accordance with the measured values of the sensor data;
obtaining pressure data from the model near a leak location in the model of the hydrocarbon production network;
generating the leak at the leak location;
executing a simulation of the model including the leak; and
determining that a simulated pressure value from the simulation of the model matches the pressure data from the model within a threshold tolerance.

11. The system of claim 10, the operations further comprising:
generating a pressure boundary condition, wherein determining that the simulated pressure value from the simulation of the model matches the pressure data is based on the pressure boundary condition.

12. The system of claim 8, wherein executing the simulation of the model occurs in real-time relative to the leak occurring in the hydrocarbon production network.

13. The system of claim 8, wherein generating the estimate of lost production from the leak in the hydrocarbon production network comprises:
determining a time period of the leak;
determining a flow of the fluid to the leak based on one or more pressure values near the leak; and
based on the one or more pressure values and the time period, determine a volume of hydrocarbons lost in the leak.

14. The system of claim 13, wherein the volume of hydrocarbons includes gaseous hydrocarbons, aqueous hydrocarbons, or both.

15. One or more non-transitory computer readable media storing instructions that, when executed by when executed by at least one processor, cause the at least one processor to perform operations comprising:
accessing a model of a hydrocarbon production network, the model specifying values for operational parameters representing operation of at least one well in the hydrocarbon production network, at least one pipeline in the hydrocarbon production network, and a fluid transported in the hydrocarbon production network;
calibrating the model based on values of sensor data measured from one or more sensors in the hydrocarbon production network, the sensor data representing operation of the hydrocarbon production network;
detecting a leak in the hydrocarbon production network;
executing a simulation of the model, wherein the detected leak in the hydrocarbon production network is inserted into the model; and
generating an estimate of lost production from the leak in the hydrocarbon production network.

16. The one or more non-transitory computer readable media of claim 15, wherein accessing a model of the hydrocarbon production network comprises:
obtaining network data describing the hydrocarbon production network, the network data comprising well data describing a configuration of the at least one well in the hydrocarbon production network, pipeline data describing the at least one pipeline in the hydrocarbon production network, and fluid data describing the fluid transported in the hydrocarbon production network; and
configuring the at least one well, the at least one pipeline, and a flow of the fluid based on the network data.

17. The one or more non-transitory computer readable media of claim 15, wherein calibrating the model of the hydrocarbon production network comprises:
obtaining sensor data comprising pressure data and flow data;
based on measured values of the sensor data, adjusting operational parameter values of the at least one well, the at least one pipeline, and a flow of the fluid in accordance with the measured values of the sensor data;
obtaining pressure data from the model near a leak location in the model of the hydrocarbon production network;
generating the leak at the leak location;
executing a simulation of the model including the leak; and
determining that a simulated pressure value from the simulation of the model matches the pressure data from the model within a threshold tolerance.

18. The one or more non-transitory computer readable media of claim 17, the operations further comprising:
generating a pressure boundary condition, wherein determining that the simulated pressure value from the simulation of the model matches the pressure data is based on the pressure boundary condition.

19. The one or more non-transitory computer readable media of claim 15, wherein executing the simulation of the model occurs in real-time relative to the leak occurring in the hydrocarbon production network.

20. The one or more non-transitory computer readable media of claim 15, wherein generating the estimate of lost production from the leak in the hydrocarbon production network comprises:
determining a time period of the leak;
determining a flow of the fluid to the leak based on one or more pressure values near the leak; and
based on the one or more pressure values and the time period, determine a volume of hydrocarbons lost in the leak.
